(19) United States
(12) Patent Application Publication
(10) Pub. No.: US 2021/0299530 A1
(43) Pub. Date: Sep. 30, 2021

(54) DEVICE FOR FIXING GOLF BAG

(71) Applicants: Xiamen Dalle New Energy Automobile Co., Ltd., Xiamen (CN); Evolution Electric Vehicles, Chino, CA (US)

(72) Inventor: Side DAI, Xiamen (CN)

(21) Appl. No.: 17/149,681

(22) Filed: Jan. 14, 2021

Related U.S. Application Data
(63) Continuation of application No. 16/839,104, filed on Apr. 3, 2020.

(30) Foreign Application Priority Data
Mar. 25, 2020 (CN) 202010220164.0
Mar. 25, 2020 (CN) 202020398394.1

(51) Int. Cl. A63B 55/00; B60R 9/08

(52) U.S. Cl. CPC A63B 55/408; B60R 9/08

(57) ABSTRACT

A device for securing a golf bag on a golf cart includes a handrail; a support assembly; a first fixation kit; and a second fixation kit. The support assembly is directly connected to the handrail; the first fixation kit is disposed on the handrail; and the second fixation kit is disposed on the support assembly. The second fixation kit includes a pedal, a seat disposed on the pedal, a storage bucket disposed below and fixedly connected to the seat, a fixing part disposed on the support assembly, a second lock catch secured to the fixing part, and a second retractor fixed on the support assembly and fitting with the second lock catch.

### CROSS-REFERENCE TO RELATED APPLICATIONS

This application is a continuation-in-part of U.S. Ser. No. 16/839,104 filed on Apr. 3, 2020, now pending, which claims foreign priority to Chinese Patent Application No. 202010220164.0 filed Mar. 25, 2020 and to Chinese Patent Application No. 202020398394.1 filed Mar. 25, 2020. The contents of all of these specifications are incorporated herein by reference. Inquiries from the public to applicants or assignees concerning this document or the related applications should be directed to: Matthias Scholl P. C., Attn.: Dr. Matthias Scholl Esq., 245 First Street, 18th Floor, Cambridge, Mass. 02142.

### BACKGROUND

The disclosure relates to a device for securing a golf bag on a golf cart.

Conventional golf carts include no permanent fixation device for fixing a golf bag. When a user needs to carry a golf bag, a fixation device is provisionally mounted on the rear seat of a golf cart. When the user wants to sit on the golf cart, the fixation device should be dismounted. The process is troublesome and the user must carry a series of tools to mount and dismount the fixation device.

### SUMMARY

The disclosure provides a device for securing a golf bag on a golf cart. The device comprises a handrail; a support assembly; a first fixation kit; and a second fixation kit. The support assembly is directly connected to the handrail; the first fixation kit is disposed on the handrail; and the second fixation kit is disposed on the support assembly. The first fixation kit comprises a mounting base for fixing a bag belt, two first lock catches disposed on two sides of the mounting base for winding the bag belt, and two first retractors disposed between the two first lock catches for rolling the bag belt. The two first lock catches and the two first retractors are disposed on the mounting base; the mounting base is fixed on the handrail through a fastener. The second fixation kit comprises a pedal, a seat disposed on the pedal, a storage bucket disposed below and fixedly connected to the seat, a fixing part disposed on the support assembly, a second lock catch secured to the fixing part, and a second retractor fixed on the support assembly and fitting with the second lock catch.

In a class of this embodiment, the support assembly comprises:
two vertical support tubes parallel to each other and each comprising a first end and a second end, and two first ends being respectively disposed on two ends of the handrail;
a positioning tube disposed between the two vertical support tubes;
two horizontal support tubes each comprising a first end and a second end, and two first ends respectively connected to two second ends of the two vertical support tubes;
two stiffener plates respectively disposed on two joints of the two vertical support tubes and the two horizontal support tubes;
a L-shaped bended plate stretching across the two horizontal support tubes and abutting against one end of each of the two stiffener plates; and
a stop plate disposed on two second ends of the two horizontal support tubes.

In a class of this embodiment, the support assembly further comprises a mounting plate for fixing a license tag; the mounting plate is disposed below the positioning tube and clamped between the two vertical support tubes, and comprises a plurality of through holes.

In a class of this embodiment, the two vertical support tubes are perpendicularly connected to the two horizontal support tubes, respectively.

In a class of this embodiment, the handrail is a curved tube; the mounting base comprises a bended fixing part on one end of the mounting base; the bended fixing part is slidable on the curved tube.

In a class of this embodiment, the mounting base is fixed on the handrail through a first common flat pad, a first spring washer and a first bolt; the two first lock catches is fixed on the mounting base through an enlarged flat pad, a second spring washer and a second bolt; and the two first retractors is fixed on the mounting base through a second common flat pad and a third bolt.

The following advantages are associated with the device for securing a golf bag on a golf cart according to embodiments of the disclosure. The device comprises the first fixation kit and the second fixation kit which are connected through the support assembly. The upper part and the lower part of the golf cart are respectively fixed on the first fixation kit and the second fixation kit, and the first fixation kit comprises a seat. Thus, the golf bag can be firm fixed on the golf cart and meanwhile the user can sit on the seat, thus improving the user experience.

### BRIEF DESCRIPTION OF THE DRAWINGS

FIG. 1 is a schematic diagram of a device for securing a golf bag on a golf cart according to one embodiment of the disclosure;

FIG. 2 is a schematic diagram of a device for securing two golf bags on a golf cart according to one embodiment of the disclosure;

FIG. 3 is a schematic diagram of a device for securing one golf bag on a golf cart according to one embodiment of the disclosure;

FIG. 4 shows a connection of a handrail, a support assembly, and a first fixation kit according to one embodiment of the disclosure;

FIG. 5 is a schematic diagram of a support assembly according to one embodiment of the disclosure; and

FIG. 6 is an exploded view of a first fixation kit according to one embodiment of the disclosure.

In the drawings, the following number references are used: 1. Handrail; 2. Support assembly; 21. Vertical support tube; 22. Positioning tube; 23. Mounting plate; 24. Horizontal support tube; 25. Stiffener plate; 26. L-shaped bended plate; 27. Stop plate; 3. First fixation kit; 31. Mounting base; 32. First lock catch; 33. First retractor; 4. Second fixation kit; 41. Pedal; 42. Seat; 43. Second lock catch; 44. Second retractor; 45. Fixing part; 46. Storage bucket.

### DETAILED DESCRIPTION

To further illustrate the disclosure, embodiments detailing a device for securing a golf bag on a golf cart are described below. It should be noted that the following embodiments are intended to describe and not to limit the disclosure.

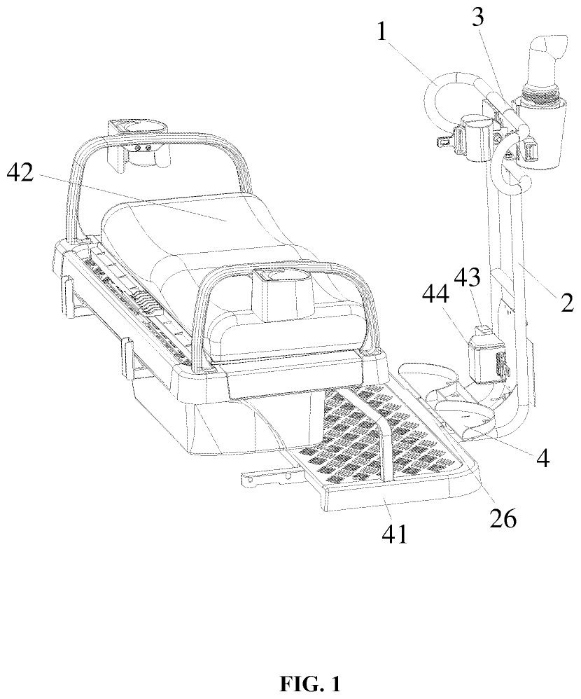

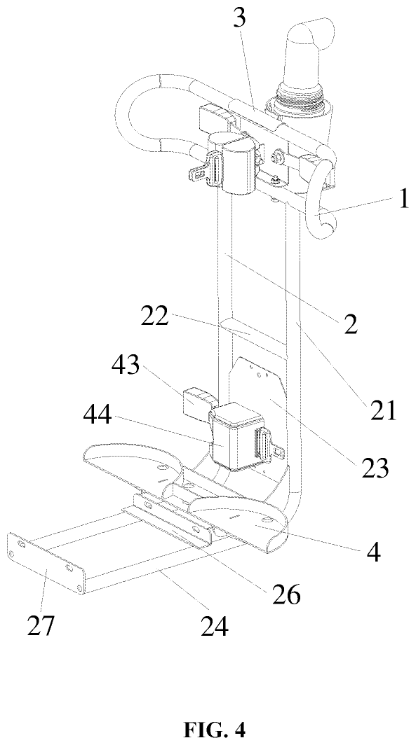

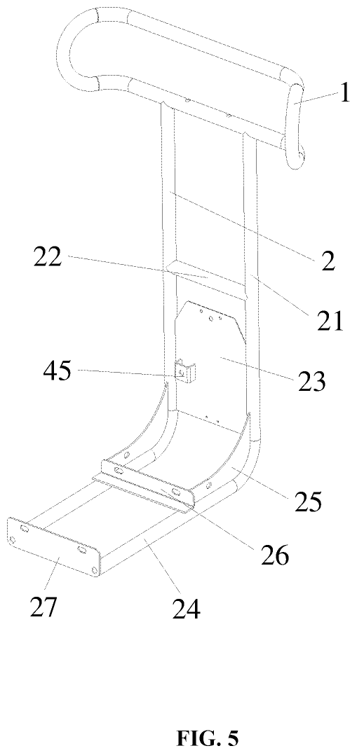

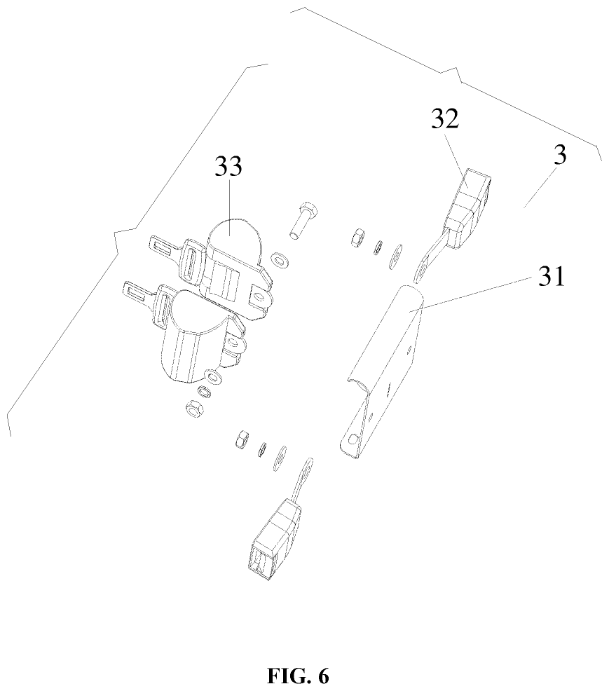

As shown in FIGS. 1-6, a device for securing a golf bag on a golf cart comprises a handrail 1; a support assembly 2; a first fixation kit 3; and a second fixation kit 4. The support assembly 2 is directly connected to the handrail 1; the first fixation kit 3 is disposed on the handrail 1; and the second fixation kit 4 is disposed on the support assembly 2.

The support assembly 2 comprises: two vertical support tubes 21 parallel to each other and comprising two first ends respectively disposed on two ends of the handrail 1 and two second ends; a positioning tube 22 disposed between the two vertical support tubes 21; two horizontal support tubes 24 comprising two first ends respectively connected to the two second ends of the two vertical support tubes 21 and two second ends; two stiffener plates 25 respectively disposed on two joints of the two vertical support tubes 21 and the two horizontal support tubes 24, thereby improving the connection stability of the two vertical support tubes 21 and the two horizontal support tubes 24; a L-shaped bended plate 26 stretching across the two horizontal support tubes 24 and abutting against one end of each of the two stiffener plates 25 for positioning the second fixation kit; and a stop plate 27 disposed on the two second ends of the two horizontal support tubes 24 for positioning the second fixation kit.

The support assembly further comprises a mounting plate 23 for fixing a license tag; the mounting plate is disposed below the positioning tube 22 and clamped between the two vertical support tubes 21, and comprises a plurality of through holes. Thus, the license tag of the golf cart is easily fixed on the device.

The two vertical support tubes 21 are perpendicularly connected to the two horizontal support tubes 24. Thus, the two vertical support tubes 21 are easily fixed on the mounting holes of the petal 41 of the second fixation kit 4 and fastened by lock bolts.

The first fixation kit 3 comprises a mounting base 31 for fixing a bag belt, two first lock catches 32 disposed on two sides of the mounting base 31 for winding the bag belt, and two first retractors 33 disposed between the two first lock catches 32 for rolling the bag belt; the two first lock catches 32 and the two first retractors 33 are disposed on the mounting base 31; the mounting base 31 is fixed on the handrail 1 through a fastener. The cooperation of the two first lock catches 32 and the two first retractors 33 facilitates the fixation of the golf bag on the golf cart.

The handrail 1, the two vertical support tubes 21, the positioning tube 22, and the two horizontal support tubes 24 are round tubes; the mounting plate 23, the two stiffener plates 25, the L-shaped bended plate 26, and the stop plate 27 employ steel plate; and a mounting base 31 of the first fixation kit 3 employ stainless steel, thereby prolonging the service life of the device.

The handrail 1 is a curved tube; the mounting base 31 comprises a bended fixing part on one end of the mounting base 31; the bended fixing part is slidable on the curved tube. The curved tube of the handrail 1 and the bended fixing part of the mounting base 31 facilitate the fixation of the golf bag and the immobilization of the mounting base 31.

The mounting base 31 is fixed on the handrail through a first common flat pad, a first spring washer and a first bolt; the two first lock catches 32 is fixed on the mounting base through an enlarged flat pad, a second spring washer and a second bolt; and the two first retractors 33 is fixed on the mounting base through a second common flat pad and a third bolt.

The second fixation kit 4 comprises a pedal 41 abutting against the L-shaped bended plate 26 of the support assembly 2, a seat 42 disposed on the pedal 41, a storage bucket 46 disposed below and fixedly connected to the seat 42, a fixing part 45 disposed on the support assembly 2, a second lock catch 43 secured to the fixing part 45, and a second retractor 44 fixed on the support assembly and fitting with the second lock catch 43. The cooperation of the second lock catch 43, the second retractor 44 and the fixing part 45 facilitates the fixation of the lower part of the golf bag.

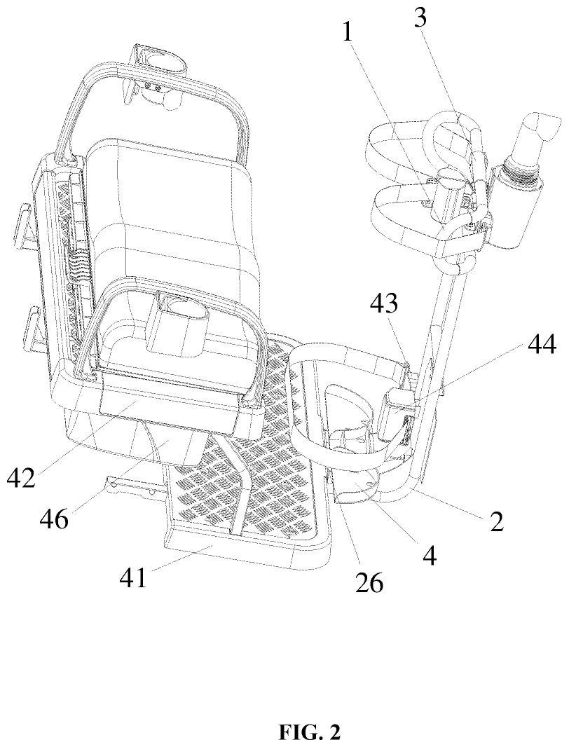

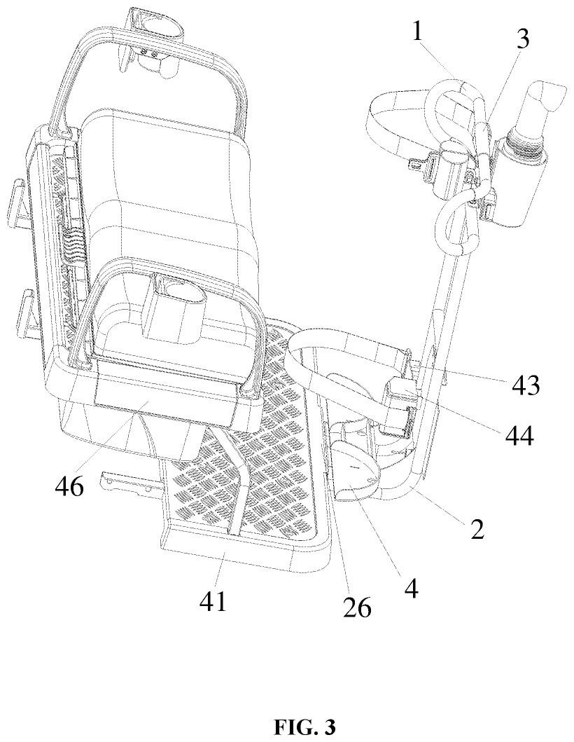

The operation of the device is detailed as follows. As shown in FIG. 3, the two first lock catches 32 and the two first retractors 33 are installed on the mounting base 31 through fasteners, whereby forming the main body of the first fixation kit 3. The first fixation kit 3 is fixed on the upper part of the handrail 1. The support assembly 2 is welded to the lower part of the handrail 1. The pedal 41 of the second fixation kit 4 is fixed between the L-shaped bended plate 26 and the stop plate 27 of the support assembly 2 through lock bolts. When two golf bags require fixation, as shown in FIG. 2, the two golf bags are obliquely placed on the pedal 41, with the neck part leaning against the curved tube of the handrail 1, and the bottom part supported by the pedal 41. The safety belts of the two first retractors 33 are pulled out and bind the neck part of the two bags on the curved tube of the handrail 1. The free ends of the safety belts are fixed on the two first lock catches 32, and thus the upper parts of the two bags are bound on the handrail. Thereafter, the safety belt of the second retractor 44 is pulled out, encircles the lower part of the two bags, and fixed on the second lock catch 43. Thus, the lower parts of the two bags are fixed. To release the two bags, push the buttons on the two first lock catches 32 and the second lock catch 43, and then the safety belts are automatically withdrawn into the two first retractors 33 and the second retractor 34. When one golf bag requires fixation, as shown in FIG. 3, the operation is basically the same as that for securing two bags, and half of the seat is unoccupied for a passenger sitting. As shown in FIG. 1, when no bags require fixation, the safety belt is rolled up and stored in the retractors, and the seat can be used by passengers.

It will be obvious to those skilled in the art that changes and modifications may be made, and therefore, the aim in the appended claims is to cover all such changes and modifications.

What is claimed is:

1. A device for securing a golf bag on a golf cart, the device comprising:
a handrail;
a support assembly;
a first fixation kit, the first fixation kit comprising a mounting base for fixing a bag belt, two first lock catches disposed on two sides of the mounting base for winding the bag belt, and two first retractors disposed between the two first lock catches for rolling the bag belt; and
a second fixation kit, the second fixation kit comprising a pedal, a seat disposed on the pedal, a storage bucket disposed below and fixedly connected to the seat, a fixing part disposed on the support assembly, a second lock catch secured to the fixing part, and a second retractor fixed on the support assembly and fitting with the second lock catch;
wherein:
the support assembly is directly connected to the handrail;
the first fixation kit is disposed on the handrail;
the second fixation kit is disposed on the support assembly; and
the two first lock catches and the two first retractors are disposed on the mounting base; the mounting base is fixed on the handrail through a fastener.

2. The device of claim 1, wherein the support assembly comprises:
two vertical support tubes parallel to each other and each comprising a first end and a second end, and two first ends being respectively disposed on two ends of the handrail;
a positioning tube disposed between the two vertical support tubes;
two horizontal support tubes each comprising a first end and a second end, and two first ends respectively connected to two second ends of the two vertical support tubes;
two stiffener plates respectively disposed on two joints of the two vertical support tubes and the two horizontal support tubes;
a L-shaped bended plate stretching across the two horizontal support tubes and abutting against one end of each of the two stiffener plates; and
a stop plate disposed on two second ends of the two horizontal support tubes.

3. The device of claim 2, wherein the support assembly further comprises a mounting plate for fixing a license tag; the mounting plate is disposed below the positioning tube and clamped between the two vertical support tubes, and comprises a plurality of through holes.

4. The device of claim 2, wherein the two vertical support tubes are perpendicularly connected to the two horizontal support tubes, respectively.

5. The device of claim 1, wherein the handrail is a curved tube; the mounting base comprises a bended fixing part on one end of the mounting base; the bended fixing part is slidable on the curved tube.

6. The device of claim 1, wherein the mounting base is fixed on the handrail through a first common flat pad, a first spring washer and a first bolt; the two first lock catches is fixed on the mounting base through an enlarged flat pad, a second spring washer and a second bolt; and the two first retractors is fixed on the mounting base through a second common flat pad and a third bolt.
